(19) United States
(12) Patent Application Publication
(10) Pub. No.: US 2019/0001408 A1
(43) Pub. Date: Jan. 3, 2019

(54) METHOD OF MANUFACTURING JOINED BODY, AND JOINING MATERIAL

(71) Applicant: Murata Manufacturing Co., Ltd., Nagaokakyo-shi (JP)

(72) Inventors: Yoshihiro Kawaguchi, Nagaokakyo-shi (JP); Masumi Noguchi, Nagaokakyo-shi (JP)

(21) Appl. No.: 16/123,134

(22) Filed: Sep. 6, 2018

Related U.S. Application Data
(63) Continuation of application No. PCT/JP2017/000465, filed on Jan. 10, 2017.

(30) Foreign Application Priority Data
Mar. 7, 2016 (JP) 2016-043557

(51) Int. Cl. B22F 1/00; B23K 35/26

(52) U.S. Cl. CPC B22F 1/0085; C22C 12/00; B23K 35/26

(57) ABSTRACT

A method of manufacturing a joined body which includes arranging a joining material containing a first metal powder and a second metal powder having a higher melting point than the first metal powder between a first member and a second member; and heating the joining material arranged between the first member and the second member. The first metal powder is formed of Sn or an alloy containing Sn, and the second metal powder is formed of a Cu—Ni alloy, a Cu—Mn alloy, a Cu—Al alloy, or a Cu—Cr alloy; a 50% volume grain size D50 of the second metal powder is 20 μm or more; and when D90 is a 90% volume grain size and D10 is a 10% volume grain size, (D90−D10)/D50 of the second metal powder is 1.6 or less.

### CROSS REFERENCE TO RELATED APPLICATIONS

The present application is a continuation of International application No. PCT/JP2017/000465, filed Jan. 10, 2017, which claims priority to Japanese Patent Application No. 2016-043557, filed Mar. 7, 2016, the entire contents of each of which are incorporated herein by reference.

### FIELD OF THE INVENTION

The present invention relates to a method of manufacturing a joined body, and a joining material.

### BACKGROUND OF THE INVENTION

As a method of mounting an electronic component on a substrate, generally, a method of soldering an electrode of an electronic component to an electrode on a substrate (a land electrode) is used.

As a solder paste to be used in such a mounting, Patent Document 1 discloses a soldering paste which contains a mixture of (a) first metal balls formed of Sn or In, (b) second metal (or alloy) balls formed of a high melting point-metal such as Cu, Al, Au, Ag, or the like, or a high melting point-alloy containing the same.

Patent Document 1 also discloses a joining method which uses the soldering paste, and a method of manufacturing an electronic device.

When conducting soldering using the soldering paste described in Patent Document 1, a low melting point-metal (e.g., Sn) balls and a high melting point-metal (e.g., Cu) balls are heated so that the low melting point-metal and the high melting point-metal react with each other to form an intermetallic compound, and objects to be joined are joined (namely, soldered) to each other through a joining portion containing the intermetallic compound.

However, in the soldering paste described in Patent Document 1, when the high melting point-metal is Cu, and the low melting point-metal is Sn, the reaction speed of Cu and Sn is slow, and accordingly, Sn, which is the low melting point-metal, remains behind. The Sn that remains behind in the first soldering step is melted and flows out in a subsequent soldering. Thus, there is a problem that reliability as a high temperature solder is low.

To solve such a problem, Patent Document 2 discloses a solder paste containing a metal component formed of a first metal powder, a second metal powder which has a higher melting point than the first metal powder, and a flux component, wherein: the first metal is Sn or an alloy containing Sn; the second metal is a metal or an alloy which produces, in combination with the first metal, an intermetallic compound which exhibits a melting point of 310° C. or more; and a lattice constant difference which is a difference between a lattice constant of the intermetallic compound and a lattice constant of the second metal component is 50% or more. As examples of the second metal, Patent Document 2 lists a Cu—Mn alloy, a Cu—Ni alloy, etc.

Patent Document 2 also discloses a joining method and a method of manufacturing an electronic device in which the solder paste is used.

According to the joining method which uses the solder paste described in Patent Document 2, a residual amount of the low melting point-component such as Sn is alleged to be reduced significantly since a reaction between the first metal (e.g., Sn) and the second metal (e.g., a Cu—Ni alloy) is promoted.
Patent Document 1: Japanese Patent Application Laid-Open No. 2002-254194
Patent Document 2: WO 2011/027659

### SUMMARY OF THE INVENTION

However, in the joining method which uses the solder paste described in Patent Document 2, since a reaction of the first metal such as Sn and the second metal such as a Cu—Ni alloy proceeds quickly, Sn or the like enters a liquid state for a short time, and an intermetallic compound having a high melting temperature is formed rapidly. As a result, voids easily occur in a joining portion. A void can also occur due to a gas derived from an organic component contained in the solder paste. Therefore, if a crack is generated from the void as a starting point, a problem such as breakage of the joining portion may occur.

The present invention has been made in order to solve the problem described above, and an object of the present invention is to provide a method of manufacturing a joined body in which a breakage of a joining portion due to a crack generated from a void as a starting point can be suppressed, and a joining material to be used in the method.

In order to achieve the purposes, the method of manufacturing a joined body of the present invention is a method of manufacturing a joined body in which a first member and a second member are joined to each other, the method including: an arrangement step in which a joining material containing a first metal powder and a second metal powder having a higher melting point than the first metal powder is arranged between the first member and the second member; and a heating step of heating the joining material arranged between the first member and the second member, to join the first member and the second member to each other; wherein the first metal powder is formed of Sn or an alloy containing Sn, and the second metal powder is formed of a Cu—Ni alloy, a Cu—Mn alloy, a Cu—Al alloy, or a Cu—Cr alloy; 50% volume grain size D50 of the second metal powder is 20 μm or more; and when D90 represents 90% volume grain size and D10 represents 10% volume grain size, (D90−D10)/D50 of the second metal powder is 1.6 or less.

The method of manufacturing a joined body of the present invention is characterized in using a second metal powder having D50 of 20 μm or more, and (D90−D10)/D50 of 1.6 or less, namely, a second metal powder having a large grain size and at the same time, a relatively narrow grain size distribution. This allows forming a void of a large size, and at the same time, a long distance to an adjacent void, in a joining portion. Provided that a powder body is formed of grains of sphere shape, and at the same time has a uniform grain size, the larger a grain size of a powder body becomes, the larger a size of void between grains of a filled powder body becomes, naturally. In practice, since a powder body has a specific grain size distribution, a powder body having a small grain size comes into void portions formed by a powder body having a large grain size, making size of voids smaller. Therefore, it is possible to increase size of voids, by making a powder body have a large grain size and a narrow grain size distribution, at the same time. By increasing a size of a void between grains of a powder body before a heat treatment, it is further possible to also increase a size of a void after the heat treatment.

As described above, in the method of manufacturing a joined body of the present invention, it is possible to form a void having a large size and a long distance to an adjacent void at the same time in a joining portion, and therefore, even when a crack is generated from a void as a starting point, it is possible to make the crack less liable to be transmitted between voids, to suppress a propagation of the crack. As a result, it is possible to suppress a breakage of the joining portion.

It is preferred that the method of manufacturing a joined body of the present invention further include a filling step, in which a void between the first member and the second member is filled with a resin, after the heating step. By filling a void in a joining portion with a resin, it is possible to reinforce the joining portion, making a joining strength higher.

In the method of manufacturing a joined body of the present invention, it is preferred that D50 of the second metal powder be 200 μm or less.

When D50 of the second metal powder exceeds 200 μm, it becomes difficult to maintain a parallelity of the first member and the second member that are objects to be joined. As a result, a crack is easily made when a thermal shock accompanied with an expansion or a contraction is given.

In the method of manufacturing a joined body of the present invention, it is preferred that (D90−D10)/D50 of the second metal powder be 0.5 or more.

When (D90−D10)/D50 of the second metal powder is less than 0.5, the second metal powder has a tendency to have larger D50, making it difficult to maintain a parallelity of the first member and the second member that are objects to be joined. As a result, a crack is easily made when a thermal shock accompanied with an expansion or a contraction is given.

In the method of manufacturing a joined body of the present invention, it is preferred that proportion of the second metal powder to a weight of the first metal powder be 40 wt % or more and 240 wt % or less.

When proportion of the second metal powder is less than 40 wt %, an amount of an intermetallic compound present in a joining portion is small, which leads to a concern that a thermal resistance is lowered. On the other hand, when proportion of the second metal powder exceeds 240 wt %, an amount of the first metal which joins the first member with the second member becomes relatively small, which leads to a concern that a joining strength is lowered.

In the method of manufacturing a joined body of the present invention, it is preferred that the first member be an electrode of an electronic component, the second member be an electrode on a substrate, and an electronic device in which the electronic component is mounted on the substrate is manufactured.

The joining material of the present invention is a joining material containing a first metal powder and a second metal powder having a higher melting point than the first metal powder, in which the first metal powder is formed of Sn or an alloy containing Sn, the second metal powder is formed of a Cu—Ni alloy, a Cu—Mn alloy, a Cu—Al alloy, or a Cu—Cr alloy, 50% volume grain size D50 of the second metal powder is 20 μm or more, and when D90 represents 90% volume grain size and D10 represents 10% volume grain size, (D90−D10)/D50 of the second metal powder is 1.6 or less.

As described above, when a joined body is manufactured by using the joining material of the present invention, it is possible to form a void which has a large size and a long distance to an adjacent void at the same time, in a joining portion. As a result, it is possible to suppress a breakage of a joining portion due to a crack generated from a void as a starting point.

In the joining material of the present invention, it is preferred that D50 of the second metal powder be 200 μm or less.

In the joining material of the present invention, it is preferred that (D90−D10)/D50 of the second metal powder be 0.5 or more.

In the joining material of the present invention, it is preferred that proportion of the second metal powder to a weight of the first metal powder be 40 wt % or more and 240 wt % or less.

According to the present invention, it is possible to provide a method of manufacturing a joined body, in which a breakage of a joining portion due to a crack generated from a void as a starting point can be suppressed, and a joining material to be used in the method.

### BRIEF EXPLANATION OF THE DRAWINGS

FIG. 1(a), FIG. 1(b), and FIG. 1(c) are views schematically showing an example of the method of manufacturing a joined body of the present invention.

FIG. 2(a), FIG. 2(b), and FIG. 2(c) are views schematically showing another example of the method of manufacturing a joined body of the present invention.

FIG. 3(a), FIG. 3(b), and FIG. 3(c) are views schematically showing an example of method of manufacturing an electronic device in which an electronic component is mounted on a substrate.

FIG. 4 is a cross sectional photograph of a joining portion in a joined body produced by using the joining material paste of Example 2.

FIG. 5 is a cross sectional photograph of a joining portion in a joined body produced by using the joining material paste of Comparative Example 2.

### DETAILED DESCRIPTION OF THE INVENTION

Hereinbelow, the method of manufacturing a joined body, and the joining material of the present invention will be described.

However, the present invention is not limited to the following structure, but may be used with an appropriate change within a scope thereof where a gist of the present invention is not changed.

Incidentally, a combination of two or more structures of the present invention described below are within the scope of the present invention.

[Method of Manufacturing Joined Body]

The method of manufacturing a joined body according to an aspect of the present invention includes: arranging a joining material which contains a first metal powder and a second metal powder having a higher melting point than the first metal powder between a first member and a second member; and heating the joining material arranged between the first member and the second member. By heating the joining material, the first metal and the second metal contained in the joining material are reacted with each other to form an intermetallic compound, and the first member and the second member are joined to each other through a joining portion containing this intermetallic compound.

It is preferred that the method of manufacturing a joined body of the present invention further include filling a void between the first member and the second member, namely, a void in the joining portion, with a resin.

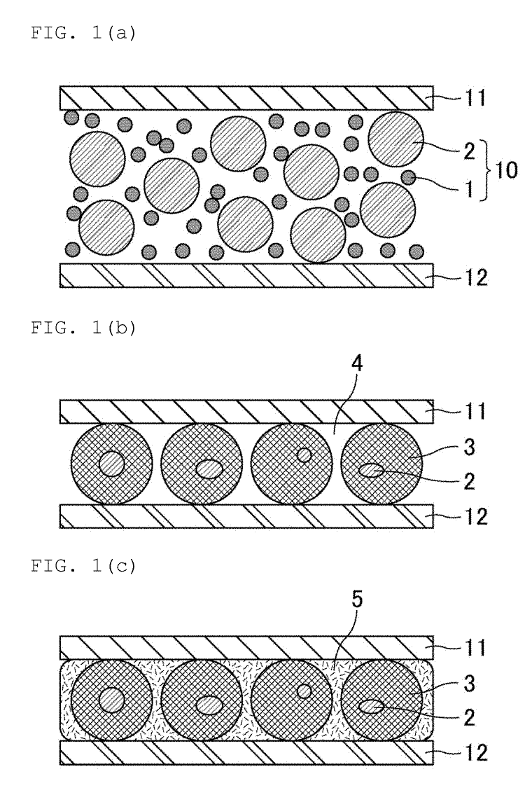

FIG. 1(a), FIG. 1(b), and FIG. 1(c) are views schematically showing an example of the method of manufacturing a joined body of the present invention.

First, as shown in FIG. 1(a), a joining material 10 containing a first metal powder 1 and a second metal powder 2 is arranged between a first member (e.g., an electrode) 11 and a second member (e.g., an electrode) 12.

Next, a heating is performed in this state, and when a temperature of the joining material 10 reaches a temperature equal to or higher than a melting point of a first metal (e.g., Sn), the first metal is melted. When the heating is further continued, the first metal and the second metal (e.g., a Cu—Ni alloy) react with each other to produce an intermetallic compound 3 (which contains e.g., (Cu, Ni)₆Sn₅), as shown in FIG. 1(b). Further, a void 4 is formed between the first member 11 and the second member 12.

Thereafter, the void 4 between the first member 11 and the second member 12 may be filled with a resin 5, as shown in FIG. 1(c).

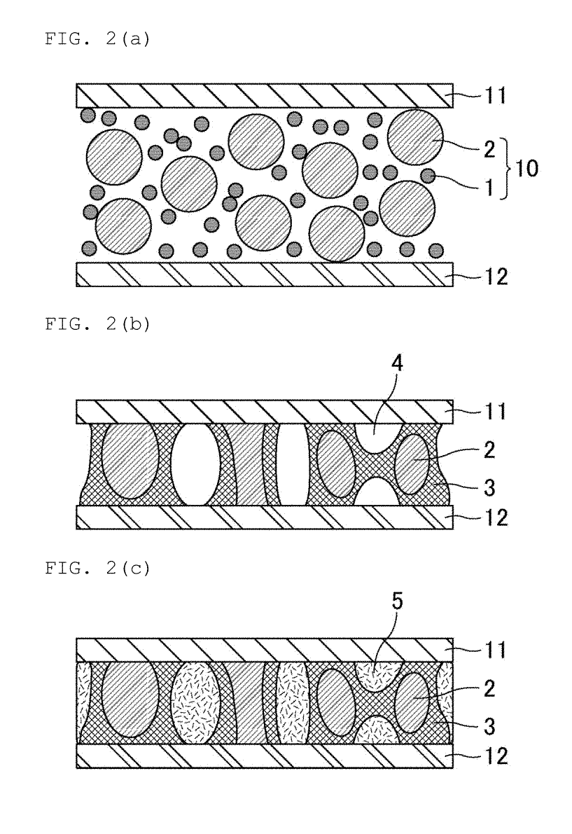

FIG. 2(a), FIG. 2(b), and FIG. 2(c) are views schematically showing an example of the method of manufacturing a joined body of the present invention.

In a case where surfaces of the first member 11 and the second member 12 are formed of a metal (e.g., Cu, Sn or an alloy containing these metal) that has a good wettability to the melted joining material 10, the second metal powder 2 and the intermetallic compound 3 sometimes deform into columnar shapes, and columns of the second metal powder 2 and the intermetallic compound 3 link to the first member 11 and the second member 12, as shown in FIG. 2(b). In a case of having such a portion in plural numbers, it is possible to also obtain an increased electrical conductivity and an increased thermal conductivity between the first member 11 and the second member 12.

In the method of manufacturing a joined body of the present invention, the resin to fill a void is not particularly limited, but preferably is a thermosetting resin, and examples thereof may include silicone resins, epoxy resins, etc.

In the method of manufacturing the joined body, the method used to fill a void with a resin is not particularly limited, but examples thereof may include a method in which a resin is poured between the first member and the second member and then cured, or a method in which a joined body of the first member and the second member is impregnated with a resin solution, and then a solvent is volatilized. In a case of manufacturing an electronic device in which an electronic component is mounted on a substrate, the method can be one in which a void is filled with a resin used in a molding.

In the method of manufacturing a joined body, it is preferred that the first member be an electrode of an electronic component (e.g., a semi-conductor chip), and the second member be an electrode on a substrate, and an electronic device in which the electronic component is mounted on the substrate is manufactured. The method of manufacturing a joined body of the present invention is particularly suitable for manufacturing a semi-conductor device of a type in which a chip is die-bonded.

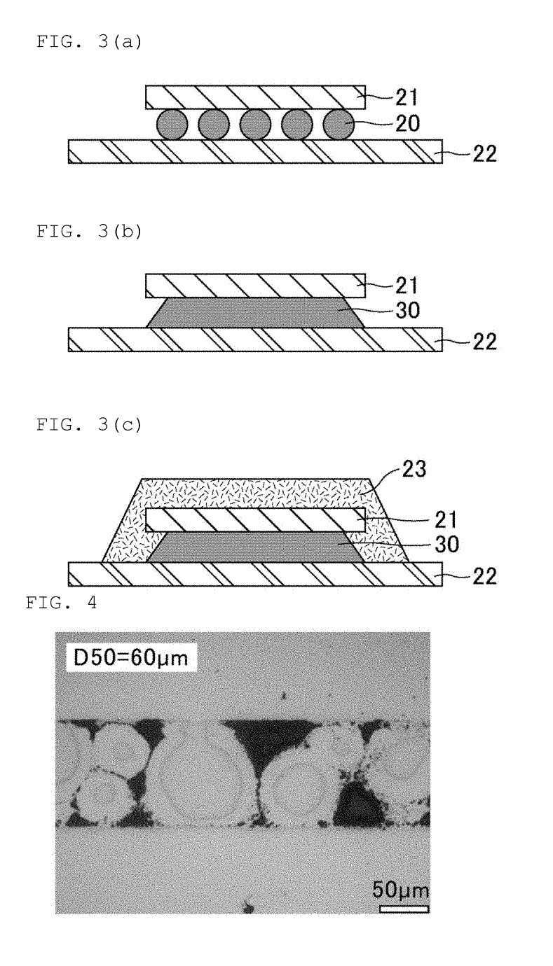

FIG. 3(a), FIG. 3(b), and FIG. 3(c) are views schematically showing an example of the method of manufacturing an electronic device in which an electronic component is mounted on a substrate.

In FIG. 3(a), FIG. 3(b), and FIG. 3(c), an electrode of the electronic component and an electrode on the substrate is omitted.

First, as shown in FIG. 3(a), a joining material 20 is arranged between an electronic component (e. G., a semi-conductor chip) 21 and a substrate 22.

Next, a heating is performed in this state, to form an intermetallic compound of the first metal and the second metal contained in the joining material, as shown in FIG. 3(b), and the electronic component 21 is die-bonded to the substrate 22 with a joining portion 30 containing this intermetallic compound interposed therebetween.

Thereafter, the electronic component 21 is molded by a resin 23, as shown in FIG. 3(c).

Although not shown in FIG. 3(c), it is preferred that the electronic component 21 be connected to a terminal of the substrate 22 by a wire bonding or the like, prior to the molding by the resin 23.

In the method of manufacturing a joined body of the present invention, in a case where the first member is an electrode of an electronic component, and the second member is an electrode on a substrate, it is preferred that each electrode be formed of Cu, Sn, or an alloy containing Cu or Sn. In this case, it is also possible that a plating layer formed of the metal or the alloy is formed on the surface of the electrodes. Although it is preferred that the plating layer be formed on an uppermost surface of the electrodes, it is also possible to form another layer such as a noble metal layer on the uppermost surface.

Incidentally, in the method of manufacturing a joined body of the present invention, the first member and the second member are not limited to electrodes. For example, it is possible that the first member is a metal wire of Cu or the like, and the second member is an electrode on a substrate or an electrode of an electronic component. The method of manufacturing a joined body of the present invention is also capable of manufacturing a joined body for those other than electronic devices.

Hereinbelow, a joining material to be used in the method of manufacturing a joined body of the present invention will be described.

This joining material is also a part of the present invention.

[Joining Material]

A joining material of the present invention contains a first metal powder and a second metal powder having a higher melting point than the first metal powder. The first metal powder is formed of Sn or an alloy containing Sn, and the second metal powder is formed of a Cu—Ni alloy, a Cu—Mn alloy, a Cu—Al alloy, or a Cu—Cr alloy.

In the joining material of the present invention, the first metal is Sn or an alloy containing Sn, and examples thereof may include Sn as a single component, and alloys containing Sn and at least one kind selected from the group consisting of Cu, Ni, Ag, Au, Sb, Zn, Bi, In, Ge, Al, Co, Mn, Fe, Cr, Mg, Mn, Pd, Si, Sr, Te, and P. Among those, Sn, Sn-3Ag-0.5Cu, Sn-3.5Ag, Sn-0.75Cu, Sn-58Bi, Sn-0.7Cu-0.05Ni, Sn-5Sb, Sn-2Ag-0.5Cu-2Bi, Sn-57Bi-1Ag, Sn-3.5Ag-0.5Bi-8In, Sn-9Zn, or Sn-8Zn-3Bi are preferred.

In the description, for example, “Sn-3Ag-0.5Cu” indicates an alloy containing 3 wt % of Ag, 0.5 wt % of Cu, and Sn as the reminder.

In the joining material of the present invention, an average grain size of the first metal powder is not particularly limited, but preferably 1 μm or more, and preferably 20 μm or less.

An average grain size refers to a grain size at a cumulative degree 50%, in a volume cumulative grain size distribution curve. More specifically, in a graph which plots grain size on the horizontal axis, and cumulative frequency from the small diameter side on the vertical axis (a volume-based grain size distribution), an average grain size (D50) corresponds to a grain size when cumulative value in terms of volume % amounts to 50% from the small diameter side with respect to a cumulative value of total grains (100%). In other words, D50 means a cumulative 50% point of particle diameter in the cumulative distribution. D50 can be measured, for example, by using a laser diffraction/scattering grain size distribution measurement device (MT3300-EX manufactured by MicrotracBEL Corp.)

In the joining material of the present invention, the second metal is a Cu—Ni Alloy, a Cu—Mn Alloy, a Cu—Al Alloy, or a Cu—Cr alloy.

The Cu—Ni alloy is preferably a Cu—Ni alloy in which proportion of Ni is 5 wt % or more and 30 wt % or less, and examples thereof may include Cu-5Ni, Cu-10Ni, Cu-15Ni, Cu-20Ni, Cu-25Ni, and Cu-30Ni.

The Cu—Mn alloy is preferably a Cu—Mn alloy in which proportion of Mn is 5 wt % or more and 30 wt % or less, and examples thereof may include Cu-5Mn, Cu-10Mn, Cu-15Mn, Cu-20Mn, Cu-25Mn, and Cu-30Mn.

The Cu—Al alloy is preferably a Cu—Al alloy in which proportion of Al is 5 wt % or more and 10 wt % or less, and examples thereof may include Cu-5Al and Cu-10Al.

The Cu—Cr alloy is preferably a Cu—Cr alloy in which proportion of Cr is 5 wt % or more and 10 wt % or less, and examples thereof may include Cu-5Cr and Cu-10Cr.

Incidentally, the second metal may contain Mn and Ni simultaneously, such as Cu-12Mn-4Ni, and may contain a third component such as P, such as Cu-10Mn-1P.

In the description above, for example, “Cu-5Ni” indicates an alloy containing 5 wt % of Ni, and Cu as the reminder. The same is also applied to Mn, Al, and Cr.

In the joining material of the present invention, 50% volume grain size D50 of the second metal powder is 20 μm or more. D50 of the second metal powder is preferably 200 μm or less.

In the joining material of the present invention, when D90 represents 90% volume grain size, and D10 represents 10% volume grain size, (D90−D10)/D50 of the second metal powder is 1.6 or less. It is preferred that (D90−D10)/D50 of the second metal powder be 0.5 or more.

Each of 50% volume grain size D50, 90% volume grain size D90, and 10% volume grain size D10 corresponds to a grain size at 50% cumulative degree, a grain size at 90% cumulative degree, and a grain size at 10% cumulative degree, respectively. More specifically, in a graph which plots grain size on the horizontal axis, and cumulative frequency from the small diameter side on the vertical axis (a volume-based grain size distribution), D50, D90, and D10 respectively corresponds to a grain size when cumulative value from the small diameter side in terms of volume % is 50%, 90%, and 10% with respect to a cumulative value of total grains (100%). It is possible to measure D50, D90, and D10, for example, by using laser diffraction/scattering grain size distribution measurement device (MT3300-EX manufactured by MicrotracBEL Corp.).

In the joining material of the present invention, proportion of a weight of the second metal powder relative to a weight of the first metal powder is not particularly limited, but preferably 40 wt % or more, and preferably 240 wt % or less.

The joining material of the present invention preferably contains a flux. In this case, the joining material of the present invention is capable of being used as a so-called solder paste.

A flux has a function of removing an oxide film on a surface of an object to be joined or of a metal. Those capable of being used as a flux are publicly known various substances formed of, for example, a vehicle, a solvent, a thixotropic agent, an activator, etc.

Specific examples of the vehicle may include rosin-based resins formed of a derivative such as rosin and a modified rosin obtained by modifying a rosin, synthetic resins, and mixtures thereof.

Specific examples of the rosin-based resins formed of derivatives such as rosin and a modified rosin obtained by modifying a rosin may include gum rosins, tall rosins, wood rosins, polymerized rosins, hydrogenated rosins, formylated rosins, rosin esters, rosin-modified maleic acid resins, rosin modified phenolic resins, rosin modified alkyd resins, and other various rosin derivatives, etc.

Specific examples of the synthetic resins formed of a derivative such as rosin and a modified rosin obtained by modifying rosin may include polyester resins, polyamide resins, phenoxy resins, terpene resins, etc.

Those known as the solvent are alcohols, ketones, esters, ethers, aromatic series, hydrocarbons, and specific examples thereof may include benzyl alcohol, ethanol, isopropyl alcohol, butanol, tetraethylene glycol, diethylene glycol, ethylene glycol, glycerin, ethyl cellosolve, butyl cellosolve, ethyl acetate, butyl acetate, benzoic acid butyl, diethyl adipate, dodecane, tetradecene, α-terpineol, terpineol, 2-methyl 2,4-pentanediol, 2-ethyl hexanediol, toluene, xylene, propylene glycol monophenyl ether, diethylene glycol monohexyl ether, ethylene glycol monobutyl ether, diethylene glycol monobutyl ether, diisobutyl adipate, hexylene glycol, cyclohexane dimethanol, 2-terpinyloxy ethanol, 2-dihydroterpinyloxy ethanol, and mixtures thereof.

Specific examples of the thixotropic agents may include hydrogenated castor oil, carnauba wax, amides, hydroxy fatty acids, dibenzylidene sorbitol, bis(p-methylbenzylidene)sorbitols, beeswax, stearamide, hydroxystearic acid ethylene bisamide, etc. As necessary, the above may also be used as a thixotropic agent also with an addition of a fatty acid such as caprylic acid, lauric acid, myristic acid, palmitic acid, stearic acid, behenic acid, a hydroxy fatty acid such as 1,2-hydroxy stearic acid, an antioxidant, a surfactant, amines, etc.

Those to be listed as the activator are hydrohalogenic acid salts of amine, organohalogen compounds, organic acids, organic amines, polyhydric alcohols, etc.

Specific examples of the hydrohalogenic acid salts of amine may include diphenylguanidine hydrobromide, diphenylguanidine hydrochloride, cyclohexylamine hydrobromide, ethylamine hydrochloride, ethylamine hydrobromide, diethylaniline hydrobromide, diethylaniline hydrocloride, triethanolamine hydrobromide, monoethanolamine hydrobromide, etc.

Specific examples of the organohalogen compounds may include chlorinated paraffins, tetrabromoethane, dibromopropanol, 2,3-dibromo-1,4-butanediol, 2,3-dibromo-2-butene-1,4-diol, tris(2,3-dibromopropyl) isocyanurate, etc.

Specific examples of the organic acids may include malonic acid, fumaric acid, glycolic acid, citric acid, malic acid, succinic acid, phenylsuccinic acid, maleic acid, salicylic acid, anthranilic acid, glutaric acid, suberic acid, adipic acid, sebacic acid, stearic acid, abietic acid, benzoic acid, trimellitic acid, pyromellitic acid, dodecanoic acid, etc.

Specific examples of the organic amines may include monoethanolamine, diethanolamine, triethanolamine, tributylamine, aniline, diethylaniline, etc.

Specific examples of the polyhydric alcohols may include erythritol, pyrogallol, ribitol, etc.

As the flux, it is also possible to use those containing at least one kind selected from the thermosetting resin group consisting of epoxy resins, phenolic resins, polyimide resins, silicone resins or modified resins thereof, and acrylic resins; or at least one kind selected from the thermoplastic resin group consisting of polyamide resins, polystyrene resins, polymethacrylic resins, polycarbonate resins, and cellulose-based resins.

As described above, the joining material of the present invention preferably contains a flux, since a flux has a function of removing an oxide film on a surface of an object to be joined or of a metal. Content of flux is preferably 7 wt % or more and 15 wt % or less relative to a total weight of the joining material.

The joining material of the present invention does not necessarily contain a flux, and may also be applied to a joining method which does not need a flux. For example, it is also possible to manufacture a highly reliable joined body by removing an oxide film on a surface of an object to be joined or of a metal, by a method of heating with applying a pressure, a method of heating in a strong reducing atmosphere, or the like.

### EXAMPLES

Hereinbelow, Examples which disclose the present invention more concretely will be shown. However, the present invention is not limited only to the Examples.

[Production of Joining Material]

### Example 1

In Example 1, a joining material paste was produced by mixing a first metal powder, a second metal powder, and a flux together.

As the first metal powder, Sn powder was used. Average grain size of the first metal powder was set to 20 μm.

As the second metal powder, Cu-10Ni powder was used. Proportion of the second metal powder to a weight of the first metal powder was set to 50 wt %, and the second metal powder was configured to have D50 of 20 μm, and (D90−D10)/D50 of 1.54. As the second metal powder, a powder produced by an atomizing method was used.

The flux used herein had following blend percentages: tetraethyleneglycol: 90 wt %, malonic acid: 5 wt %, and hydrogenated castor oil: 5 wt %. Proportion in the total paste occupied by the flux was set to 10 wt %.

### Example 2

A joining material paste was produced similarly as in Example 1, except that D50 and (D90−D10)/D50 of the second metal powder were changed to 60 μm and 1.02, respectively.

### Example 3

A joining material paste was produced similarly as in Example 1, except that D50 and (D90−D10)/D50 of the second metal powder were changed to 80 μm and 0.69, respectively.

### Example 4

A joining material paste was produced similarly as in Example 1, except that D50 and (D90−D10)/D50 of the second metal powder were changed to 200 μm and 0.57, respectively.

### Example 5

A joining material paste was produced similarly as in Example 1, except that D50 and (D90−D10)/D50 of the second metal powder were changed to 250 μm and 0.57, respectively.

### Comparative Example 1

A joining material paste was produced similarly as in Example 1, except that D50 and (D90−D10)/D50 of the second metal powder were changed to 10 μm and 1.73, respectively.

### Comparative Example 2

A joining material paste was produced similarly as in Example 1, except that D50 and (D90−D10)/D50 of the second metal powder were changed to 5 μm and 1.37, respectively.

[Production of Joined Body]

The joining material pastes of Examples 1 to 5 and Comparative Examples 1 to 2 were applied to plural parts on Cu boards of 100 mm×100 mm×1 mmt, at a specific amount. Cu pieces of 10 mm×10 mm×1 mmt were arranged on the parts to which the joining materials were applied. Thereafter, preheating was performed at 130° C. or more and 180° C. or less for 70 seconds, and then a heat treatment was conducted under general reflow conditions of 220° C. or higher for 30 seconds, and peak temperature of 245° C. Thus, joined bodies were produced.

[Measurement of Void Size]

From a three-dimensional view, some of the voids formed in a joining portion communicate with each other. However, for convenience, voids were treated as in a closed-base observed in a two-dimensional face. Although the voids had indeterminate shapes, the voids were treated as circles having uniform areas, and a radius thereof was obtained as a void size.

With respect to each of the joined bodies produced by using the joining material paste of Examples 1 to 5 and Comparative Examples 1 to 2, a cross sectional photograph of a joining portion was taken by using an electron microscope, and radius was obtained from 20 voids by the method described above, to obtain an average value thereof as a “void size”.

[Measurement of Distance to Adjacent Void]

Seeing a void as a center, with plural number of adjacent voids, a distance to the void which had the shortest distance between the voids was obtained.

With respect to 20 voids in a cross sectional photograph of a joining portion taken for a measurement of void size, the distance to a void which had the shortest distance between voids, was individually obtained, and an average value thereof was taken as a “distance to an adjacent void”.

[Evaluation of Effect of Suppressing Breakage of Joining Portion]

By using joining material pastes of Examples 1 to 5 and Comparative Examples 1 to 2, a Cu board and a Cu tab line were joined to each other, and molded by a silicone resin.

A 90° detachment test in which the Cu tab line was drawn in 90° direction from the Cu board was conducted, and a stress at the time was measured. It is considered that, in a sample which exhibited a predetermined stress also after the stress marked a maximum value, no breakage of a joining portion itself occurred, even if a crack was generated in the joining portion, and thus, such a sample was evaluated as Good (G). On the other hand, a sample which exhibited stress zero after the stress marked a maximum value was evaluated as No good (NG).

[Evaluation of Parallelity of Objects to be Joined]

In the joined bodies produced for the measurement of void size, a cross section of a joining portion was individually observed by using an industrial-use microscope, and a sample in which a joined face had a shear of 10° or less was evaluated as Good (G), and a sample exceeding 10° was evaluated as No good (NG).

Table 1 shows D50 and (D90−D10)/D50 of the second metal powders, the void size, the distance to an adjacent void, the effect of suppressing breakage of joining portion, and the parallelity of object to be joined of Examples 1 to 5 and Comparative Examples 1 to 2.

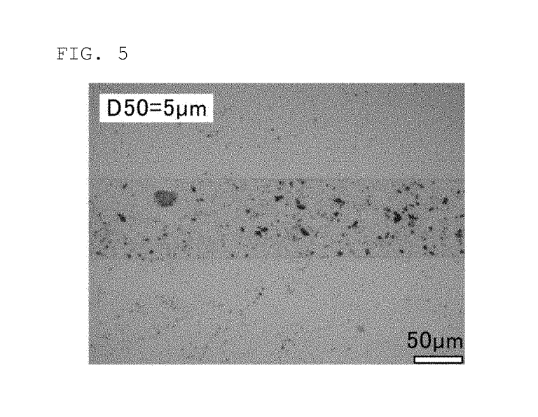

FIG. 4 shows a cross sectional photograph of a joining portion in a joined body produced by using the joining material paste of Example 2, and FIG. 5 shows a cross sectional photograph of a joining portion in a joined body produced by using the joining material paste of Comparative Example 2.

TABLE 1

| | Second | | | Distance | Effect of | Paral- |
|---|---|---|---|---|---|---|
| | metal powder | | | to | suppressing | lelity of |
| | | (D90 − | Void | adjacent | breakage | objects |
| | D50 | D10)/ | size | void | of joining | to be |
| | [μm] | D50 | [μm] | [μm] | portion | joined |
| Example 1 | 20 | 1.54 | 7 | 23 | G | G |
| Example 2 | 60 | 1.02 | 16 | 43 | G | G |
| Example 3 | 80 | 0.69 | 23 | 57 | G | G |
| Example 4 | 200 | 0.57 | 55 | 160 | G | G |
| Example 5 | 250 | 0.57 | 89 | 204 | G | NG |
| Comparative | 10 | 1.73 | 2 | 5 | NG | G |
| Example 1 | | | | | | |
| Comparative | 5 | 1.37 | 2 | 4 | NG | G |
| Example 2 | | | | | | |

From Table 1, it was confirmed that a void with a large size and a large distance to an adjacent void were formed in Examples 1 to 5 which used the second metal powder having D50 of 20 μm or more, and (D90−D10)/D50 of 1.6 or less. Therefore, it is considered that, even in a case where a crack is generated from a void as a starting point, the crack becomes less liable to propagate, and thus, it is possible to suppress a breakage of a joining portion.

In particular, Examples 1 to 4, in which D50 of the second metal powder was 200 μm or less, parallelity of objects to be joined is maintained. Therefore, it is considered that a crack is less liable to be made, even if a thermal shock accompanied with an expansion or a contraction is given.

On the other hand, in Comparative Examples 1 and 2, in which D50 of the second metal powder was less than 20 μm, it was confirmed that the void size was small, and the distance to an adjacent void was short. Therefore, when a crack is generated in a joining portion, it is considered that the crack easily propagates successively to break the joining portion.

### DESCRIPTION OF REFERENCE SYMBOLS

1: First metal powder
2: Second metal powder
3: Intermetallic compound
4: Void
5: Resin
10: Joining material
11: First member (Electrode)
12: Second member (Electrode)
20: Joining material
21: Electronic component (Semi-conductor chip)
22: Substrate
23: Resin
30: Joining portion

1. A method of manufacturing a joined body, the method comprising:
arranging a joining material between a first member and a second member, the joining material containing a first metal powder and a second metal powder having a higher melting point than the first metal powder; and
heating the joining material arranged between the first member and the second member so as to join the first member and the second member to each other,
the first metal powder including Sn or an alloy containing Sn,
the second metal powder including a Cu—Ni alloy, a Cu—Mn alloy, a Cu—Al alloy, or a Cu—Cr alloy,
a 50% volume grain size D50 of the second metal powder is 20 μm or greater, and
(D90−D10)/D50 of the second metal powder is 1.6 or less, wherein D90 is a 90% volume grain size and D10 is a 10% volume grain size.

2. The method of manufacturing a joined body according to claim 1, further comprising filling a void between the first member and the second member with a resin after the heating of the joining material.

3. The method of manufacturing a joined body according to claim 1, wherein the D50 of the second metal powder is 20 μm to 200 μm.

4. The method of manufacturing a joined body according to claim 1, wherein (D90−D10)/D50 of the second metal powder is 0.5 to 1.6.

5. The method of manufacturing a joined body according to claim 1, wherein a proportion of a weight of the second metal powder to a weight of the first metal powder is 40 wt % to 240 wt %.

6. The method of manufacturing a joined body according to claim 1, wherein the first member is an electrode of an electronic component, the second member is an electrode on a substrate, and the electronic component is mounted on the substrate.

7. The method of manufacturing a joined body according to claim 1, wherein the alloy containing Sn includes at least of Cu, Ni, Ag, Au, Sb, Zn, Bi, In, Ge, Al, Co, Mn, Fe, Cr, Mg, Mn, Pd, Si, Sr, Te, or P.

8. The method of manufacturing a joined body according to claim 1, wherein an average grain size of the first metal powder is 1 μm to 20 μm.

9. The method of manufacturing a joined body according to claim 1, wherein the joining material further contains a flux.

10. The method of manufacturing a joined body according to claim 9, wherein a content of the flux is 7 wt % to 15 wt % to a total weight of the joining material.

11. A joining material comprising:
a first metal powder including Sn or an alloy containing Sn; and
a second metal powder having a higher melting point than the first metal powder, the second metal powder including a Cu—Ni alloy, a Cu—Mn alloy, a Cu—Al alloy, or a Cu—Cr alloy, wherein
a 50% volume grain size D50 of the second metal powder is 20 μm or greater, and
(D90−D10)/D50 of the second metal powder is 1.6 or less, wherein D90 is a 90% volume grain size and D10 is a 10% volume grain size.

12. The joining material according to claim 11, wherein the D50 of the second metal powder is 20 μm to 200 μm.

13. The joining material according to claim 7, wherein (D90−D10)/D50 of the second metal powder is 0.5 to 1.6.

14. The joining material according to claim 11, wherein a proportion of a weight of the second metal powder to a weight of the first metal powder is 40 wt % to 240 wt %.

15. The joining material according to claim 11, wherein the alloy containing Sn includes at least of Cu, Ni, Ag, Au, Sb, Zn, Bi, In, Ge, Al, Co, Mn, Fe, Cr, Mg, Mn, Pd, Si, Sr, Te, or P.

16. The joining material according to claim 11, wherein an average grain size of the first metal powder is 1 μm to 20 μm.

17. The joining material according to claim 11, wherein the joining material further contains a flux.

18. The joining material according to claim 17, wherein a content of the flux is 7 wt % to 15 wt % to a total weight of the joining material.
